(19) United States
(12) Patent Application Publication
(10) Pub. No.: US 2010/0309095 A1
(43) Pub. Date: Dec. 9, 2010

(54) ELECTRONIC APPARATUS HAVING DUAL DISPLAYS

(76) Inventors: Ju-Nan Chang, Taipei Hsien (TW); Wen-Fong Chang, Taipei (TW); Yi-Peng Hsu, Taipei (TW); Hsin-Ting Lin, Taipei (TW); Qi Liu, Shanghai (CN)

Correspondence Address: NORTH AMERICA INTELLECTUAL PROPERTY CORPORATION, P.O. BOX 506, MERRIFIELD, VA, 22116, US

(21) Appl. No.: 12/780,923

(22) Filed: May 16, 2010

(30) Foreign Application Priority Data
Jun. 9, 2009 (TW) 098119183

(51) Int. Cl. G09G 5/00

(52) U.S. Cl. 345/3.1

(57) ABSTRACT

An electronic apparatus having dual displays includes a casing, a circuit board, an electronic-paper display and a non-electronic-paper display. The casing has a first side and a second side. The circuit board is disposed in the casing. The electronic-paper display is disposed on the first side of the casing and connected to the circuit board. The non-electronic-paper display is disposed on the second side of the casing and connected to the circuit board. The electronic-paper display can be used for displaying a text document, and the non-electronic-paper display can be used for displaying high quality image data, e.g. a streaming media. Based on the attribute of a file, a user can select an appropriate display for displaying the file so as to make good use of the electronic apparatus.

### BACKGROUND OF THE INVENTION

1. Field of the Invention

The invention relates to an electronic apparatus and, more particularly, to an electronic apparatus having at least dual displays.

2. Description of the Prior Art

Generally speaking, an electronic apparatus, such as mobile phone, Personal Digital Assistant (PDA) and so on, is equipped with display for displaying information for a user. At present, most of the displays installed in the conventional electronic apparatuses are Liquid Crystal Displays (LCDs). The response speed of LCDs is fast, the color effect of LCDs is good, and for those reasons, LCDs are suitable for displaying high quality information, such as a streaming media and so on. However, since LCDs are equipped with a transmissive backlight, a backlight source is required. Therefore, the user needs to set himself or herself in an appropriate view angle that he or she can see the displayed image clearly, and it limits his or her pose of reading. Furthermore, there is no memory effect after power of LCDs is cut off, i.e., the displayed image disappears and is unable to be maintained with cut-off power.

On the other hand, unlike the conventional LCDs, there are also many electronic apparatuses (e.g. electronic books) equipped with electronic-paper display for purpose of reading. The electronic paper is made of conductive polymeric material including many small spheres (such as capsules), the appearance and the characteristic of the electronic paper are the same with normal paper, and the electronic paper is flexible and capable of displaying information repetitively. The electronic paper is capable of utilizing outer light source to display images, and it is unlike LCDs that need a backlight source. Therefore, information on the electronic paper can be seen clearly in the outdoor environment of strong sunlight with any view angles. Furthermore, the electronic paper possesses characteristics of light, thin, foldable, portable, energy-saving and so on. Accordingly, the electronic paper is very suitable for displaying information such as text documents and so on. However, the response speed of the electronic-paper displays is slow and the color is monotonous with respect to LCDs, and the electronic-paper displays are not suitable for displaying high quality information, such as a streaming media and so on.

### SUMMARY OF THE INVENTION

In order to solve the aforesaid drawbacks, an objective of the invention is to provide an electronic apparatus having at least dual displays.

According to one embodiment, an electronic apparatus having at least dual displays of the invention comprises a casing, a circuit board, an electronic-paper display, a non-electronic-paper display and a processor. The casing has a first side and a second side. The circuit board is disposed in the casing. The electronic-paper display is disposed on the first side of the casing and electrically connected to the circuit board. The non-electronic-paper display is disposed on the second side of the casing and electrically connected to the circuit board. The processor is disposed in the casing and electrically connected to the circuit board. The processor is used to control operation of the electronic-paper display and operation of the non-electronic-paper display. In this embodiment, the non-electronic-paper display can be, but not limited to, an LCD.

According to the electronic apparatus having at least dual displays of the invention, when a user wants to see a text document by using the electronic apparatus, he or she may choose the electronic-paper display to display the text document; and when he or she wants to see high quality information, such as a streaming media and so on by using the electronic apparatus, he or she may choose the non-electronic-paper display to display the streaming media. In other words, the user may choose the suitable display to display a file according to the attribute of the file, so as to make good use of the electronic apparatus.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a perspective view illustrating the electronic apparatus according to one embodiment of the invention.

FIG. 2 is a perspective view illustrating the electronic apparatus of FIG. 1 in another view angle.

FIG. 3 is a schematic diagram illustrating an arrangement of the electronic-paper display, the non-electronic-paper display and the circuit board.

FIG. 4 is a functional block diagram illustrating the electronic apparatus of FIG. 1.

FIG. 5 is a schematic diagram illustrating an arrangement of the electronic-paper display, the non-electronic-paper display and the circuit board according to another embodiment of the invention.

### DETAILED DESCRIPTION

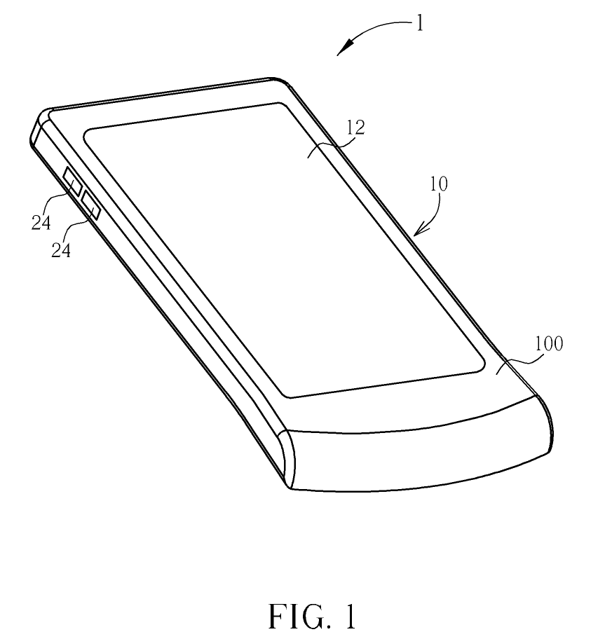

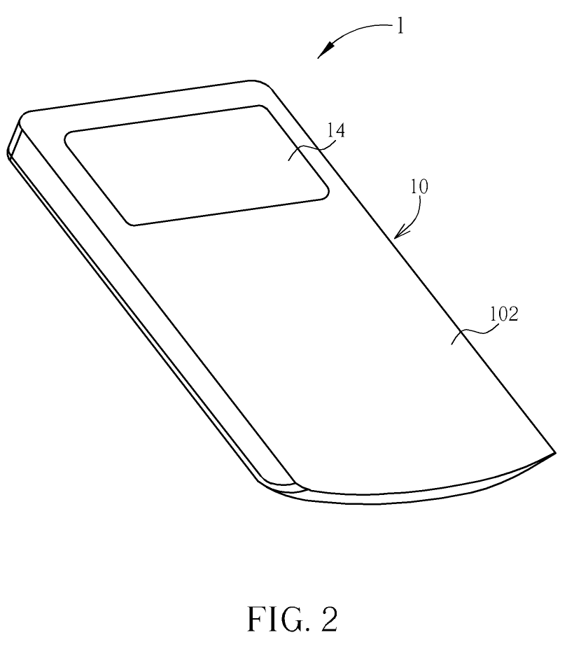

Referring to FIG. 1 and FIG. 2, FIG. 1 is a perspective view illustrating an electronic apparatus 1 according to one embodiment of the invention, and FIG. 2 is a perspective view illustrating the electronic apparatus 1 of FIG. 1 in another view angle. As shown in FIG. 1 and FIG. 2, the electronic apparatus 1 comprises a casing 10, an electronic-paper display 12 and a non-electronic-paper display 14. The casing 10 has a first side 100 and a second side 102. The electronic-paper display 12 is disposed on the first side 100 of the casing 10 and the non-electronic-paper display 14 is disposed on the second side 102 of the casing 10. In this embodiment, if the first side 100 is front side of the electronic apparatus 1, the second side 102 is rear side of the electronic apparatus 1, and vice versa.

In this embodiment, the electronic apparatus 1 can be a mobile phone, a PDA or any electronic apparatus capable of displaying a streaming media, a text document and so on. The electronic-paper display 12 can be a microcapsules electrophoretic display manufactured by pouring black and white particles with charges into two transparent glass or plastic substrates. When a voltage is applied across the two substrates, the particles with different colors will be attracted to float or sink, so as to perform an image. Besides, gyricon or cholesteric display technology can also be applied to the electronic-paper display 12 based on practical applications.

Since the electronic-paper display 12 is flexible and foldable, the appearance of the casing 10 on the first side 100 of the electronic-paper display 12 has a great diversity of designs. Besides, the non-electronic-paper display 14 can be an LCD or any display capable of displaying a streaming media and so on. It should be noticed that the principle of the electronic-paper display 12, LCD or any non-electronic-paper display 14 applied in the invention can be achieved by one skilled in the art, so it will not be depicted here again.

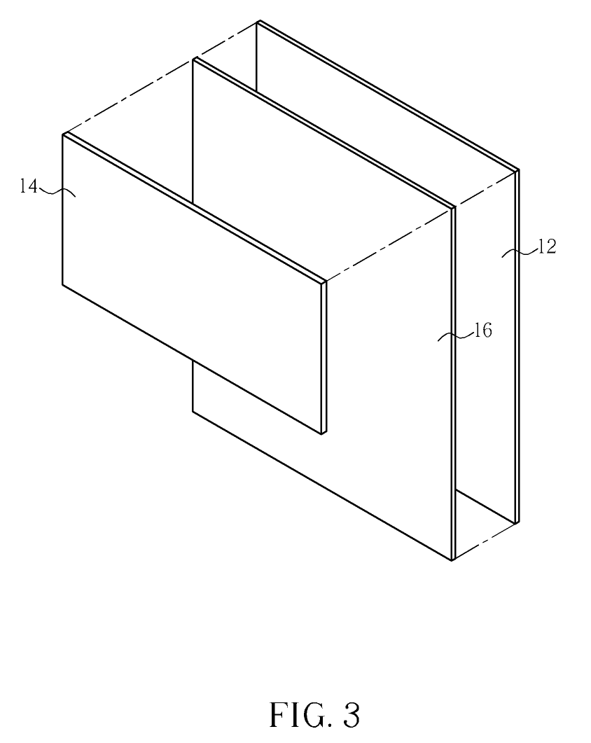

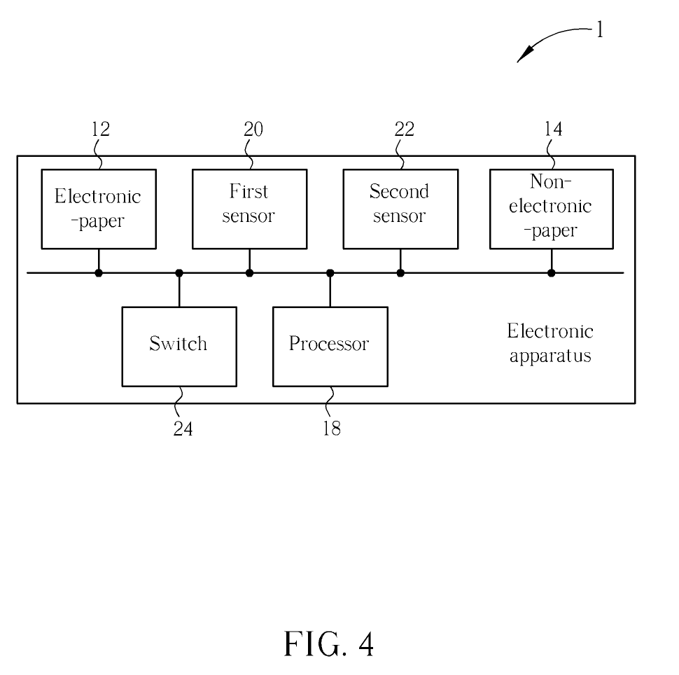

Referring to FIG. 3 and FIG. 4, FIG. 3 is a schematic diagram illustrating an arrangement of the electronic-paper display 12, non-electronic-paper display 14 and the circuit board 16, and FIG. 4 is a functional block diagram illustrating the electronic apparatus 1 of FIG. 1. As shown in FIG. 3 and FIG. 4, in addition to the casing 10, the electronic-paper display 12 and the non-electronic-paper display 14 mentioned above, the electronic apparatus 1 of the invention further comprises a circuit board 16, a processor 18, a first sensor 20, a second sensor 22 and a switch 24. The circuit board 16, the processor 18, the first sensor 20, the second sensor 22 and the switch 24 are disposed in the casing 10. The electronic-paper display 12, the non-electronic-paper display 14, the processor 18, the first sensor 20, the second sensor 22 and the switch 24 are electrically connected to the circuit board 16 respectively, such that the processor 18 can be used to switch between use of the electronic-paper display 12 and use of the non-electronic-paper display 14 in response to a user's operation.

In this embodiment, the switch 24 can control the processor 18 to switch between use of the electronic-paper display 12 and use of the non-electronic-paper display 14. Since the electronic-paper display 12 can utilize outdoor light source to display image with any view angles, the user may operate the switch 24 to choose the electronic-paper display 12 to display a text document when he or she needs to read the text document. A backlight source is not required in the electronic-paper display 12, and the electronic-paper display 12 does not consume energy besides changing the display content. In other words, the electronic-paper display 12 possesses memory characteristic of maintaining display status after the power is cut off, and it is different from normal displays. Therefore, it can save energy of the electronic apparatus 1 by using the electronic-paper display 12 to display the text document, so as to prolong standby time of the electronic apparatus 1. On the other hand, when the user wants to use the electronic apparatus 1 to display high quality information, such as a streaming media and so on, he or she may operate the switch 24 to choose the non-electronic-paper display 14 to display the streaming media and so on. In other words, the user may operate the switch 24 to switch between use of the electronic-paper display 12 and use of the non-electronic-paper display 14 according to an attribute of a file. In practical application, the switch 24 can be designed as, but not limited to, a bottom disposed on the casing 10 for the user to enable displays conveniently, as shown in FIG. 1.

The user may manually operate the switch 24 or use the second sensor 22 to switch between use of the electronic-paper display 12 and use of the non-electronic-paper display 14. In this embodiment, the second sensor 22 can be a G sensor. The invention may be implemented by driving the second sensor 22 to send a sensing signal to the processor 18 when the second sensor 22 senses that the user shakes the casing 10 of the electronic apparatus 1 (for example, shaking the casing 10 two times). Afterwards, the processor 18 switches between use of the electronic-paper display 12 and use of the non-electronic-paper display 14 according to the sensing signal corresponding to the operation. For example, when the user shakes the casing 10 two times, the processor 18 will switch from current use of the electronic-paper display 12 to use of the non-electronic-paper display 14 to display, or switch from current use of the non-electronic-paper display 14 to use of the electronic-paper display 12 to display. In another embodiment, the second sensor 22 can be a magnetic sensor or any sensor capable of sensing the operation of the user, and it depends on practical application.

Besides, in another embodiment, the invention can also make the processor 18 to switch between use of the electronic-paper display 12 and use of the non-electronic-paper display 14 according to an attribute of a file via software programming. For example, when the user opens a file, and the processor 18 determines that the attribute of the file is a text document, the processor 18 chooses the electronic-paper display 12 to display the file. On the other hand, when the user opens a file, and the processor 18 determines that the attribute of the file is a streaming media, the processor 18 chooses the non-electronic-paper display 14 to display the file. Accordingly, it is more convenient in usage.

The first sensor 20 is used for sensing an environmental parameter and then sending a sensing signal to the processor 18. The processor 18 changes a display color of the electronic-paper display 12 according to the sensing signal corresponding to the environmental parameter. In this embodiment, the first sensor 20 can be temperature sensor and the environmental parameter can be temperature. For example, via software programming, when the first sensor 20 senses that the current temperature is 25° C, the first sensor 20 will send a sensing signal to the processor 18, so as to make the processor 18 choose the electronic-paper display 12 to display red; when the first sensor 20 senses that the current temperature changes from 25° C to 20° C., the first sensor 20 will send a sensing signal to the processor 18, so as to make the processor 18 choose the electronic-paper display 12 to display from red to orange; and so on. Accordingly, the user may know the current temperature and the changes of temperature via the changes of colors displayed by the electronic-paper display 12.

Furthermore, in another embodiment, the first sensor 20 can also be a pulse sensor, and the environmental parameter can be pulse frequency. For example, via software programming, when the first sensor 20 senses that the user's current pulse is between 50 to 70 times/minutes, the first sensor 20 will send a sensing signal to the processor 18, so as to make the processor 18 choose the electronic-paper display 12 to display green; when the first sensor 20 senses that the user's current pulse is between 70 to 90 times/minutes, the first sensor 20 will send a sensing signal to the processor 18, so as to make the processor 18 choose the electronic-paper display 12 to display from green to red; and so on. The user can know the current changes of pulses and then check his or her physical condition via the changes of colors displayed by the electronic-paper display 12.

In the invention, the user maybe allowed to change the display color of the electronic-paper display 12 according to his or her preference. Furthermore, the user may also change the display color of the electronic-paper display 12 according to the theme of the screen. Because a backlight source is not required in the electronic-paper display 12, the electronic-paper display 12 does not consume energy besides changing display colors. In other words, the electronic-paper display 12 is capable of maintaining current display colors after the power is cut off, so it is beautiful and saves energy of the electronic apparatus 1.

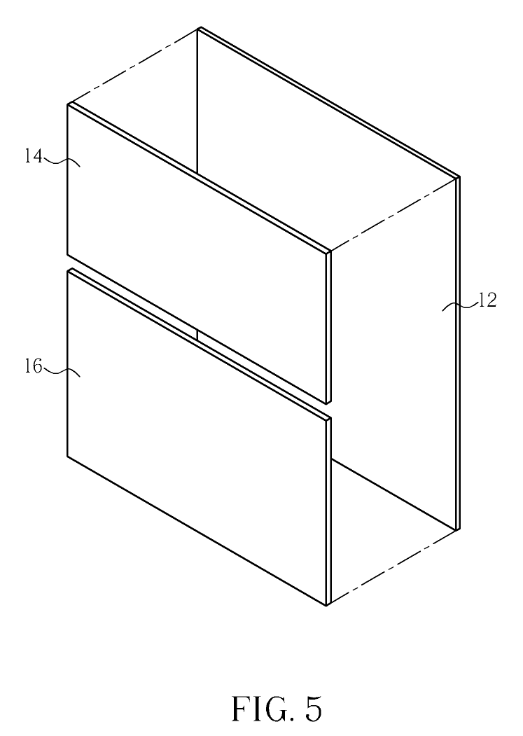

Referring to FIG. 5, FIG. 5 is a schematic diagram illustrating an arrangement of the electronic-paper display 12, the non-electronic-paper display 14 and the circuit board 16 according to another embodiment of the invention. The major difference between FIG. 5 and FIG. 3 is that the circuit board 16 of FIG. 5 is disposed under the non-electronic-paper display 14. Accordingly, it can further reduce the volume of the electronic apparatus 1.

Compared to the prior art, according to the electronic apparatus having dual displays of the invention, when a user wants to see a text document by using the electronic apparatus, he or she may choose the electronic-paper display to display the text document; and when he or she wants to see high quality information, such as a streaming media and so on by using the electronic apparatus, he or she may choose the non-electronic-paper display to display the streaming media. In other words, the user may choose the suitable display to display a file according to the attribute of the file, so as to make good use of the electronic apparatus. Furthermore, the display color of the electronic apparatus is changeable according to the user's preference, and it is beautiful and energy-saving.

Those skilled in the art will readily observe that numerous modifications and alterations of the device and method may be made while retaining the teachings of the invention.

What is claimed is:

1. An electronic apparatus having at least dual displays, comprising:
a casing having a first side and a second side;
a circuit board disposed in the casing;
an electronic-paper display disposed on the first side of the casing and electrically connected to the circuit board; and
a non-electronic-paper display disposed on the second side of the casing and electrically connected to the circuit board.

2. The electronic apparatus of claim 1, wherein the non-electronic-paper display is a liquid crystal display.

3. The electronic apparatus of claim 1 further comprising a processor disposed in the casing and electrically connected to the circuit board, the processor being used to control operation of the electronic-paper display and operation of the non-electronic-paper display.

4. The electronic apparatus of claim 3 further comprising a first sensor disposed in the casing and electrically connected to the circuit board, the first sensor being used to sense an environmental parameter and the processor being used to change a display color of the electronic-paper display according to the environmental parameter.

5. The electronic apparatus of claim 4, wherein the first sensor is a temperature sensor and the environmental parameter is temperature.

6. The electronic apparatus of claim 4, wherein the first sensor is a pulse sensor and the environmental parameter is pulse frequency.

7. The electronic apparatus of claim 3 further comprising a second sensor disposed in the casing and electrically connected to the circuit board, the second sensor being used to sense an operation, and the processor being used to switch between use of the electronic-paper display and use of the non-electronic-paper display according to the operation.

8. The electronic apparatus of claim 7, wherein the second sensor is a G sensor or a magnetic sensor.

9. The electronic apparatus of claim 3 further comprising a switch disposed on the casing and electrically connected to the circuit board, the switch being used for the processor to switch between use of the electronic-paper display and use of the non-electronic-paper display.

10. The electronic apparatus of claim 3, the processor being used to switch between use of the electronic-paper display and use of the non-electronic-paper display according to an attribute of a file, wherein the file is to be displayed.

11. The electronic apparatus of claim 10, wherein the processor chooses the electronic-paper display to display the file if the processor determines that the file comprises a text document according to the attribute.

12. The electronic apparatus of claim 10, wherein the processor chooses the non-electronic-paper display to display the file if the processor determines that the file comprises streaming media according to the attribute.
